(19) United States
(12) Patent Application Publication
(10) Pub. No.: US 2025/0256629 A1
(43) Pub. Date: Aug. 14, 2025

(54) SEAT CUSHION

(71) Applicant: TOYOTA BOSHOKU KABUSHIKI KAISHA, Aichi-ken (JP)

(72) Inventors: Masahiko IYODA, Nagakute-shi (JP); Takeshi USHIYAMA, Toyota-shi (JP); Yuji NAKANO, Nissin-shi (JP)

(73) Assignee: TOYOTA BOSHOKU KABUSHIKI KAISHA, Aichi-ken (JP)

(21) Appl. No.: 19/050,776

(22) Filed: Feb. 11, 2025

(30) Foreign Application Priority Data
Feb. 14, 2024 (JP) 2024-020008

(51) Int. Cl. B60N 2/68; B60N 2/10; B60N 2/58; B60N 2/90

(52) U.S. Cl. CPC B60N 2/686; B60N 2/10; B60N 2/5825; B60N 2/929

(57) ABSTRACT

A seat cushion has a seat frame and a cushion body. The cushion body includes a main top panel defining a center portion in a seat width direction, and respective side top panels defining side portions in the seat width direction. The main top panel includes a main pad and a base material attached to a backside of the main pad. The side top panels include side pads and side bases attached to backsides of the side pads and secured to the seat frame. A first fitting portion is provided between the main base and side bases and configured to fit the main base to side bases in a seat height direction upon insertion of the main base from a seat upward direction. A second fitting portion is provided to allow the main base to be snap-fitted to each side base from a seat forward direction.

### CROSS-REFERENCE TO RELATED APPLICATIONS

This application claims priority to Japanese patent application serial number 2024-20008 filed Feb. 14, 2024, the contents of which are incorporated herein by reference in their entirety for all purposes.

### BACKGROUND

The present invention relates to a seat cushion. More particularly, it relates to a seat cushion having a cushion body for elastically supporting a seated person and a seat frame for supporting the cushion body from backside of a seat.

Conventionally, a seat cushion has a cushion body divided into three sections in a seat width direction. The cushion body is composed of a seat pad and a seat cover enclosing the seat pad. The cushion body is divided into a main top panel forming a center portion in the seat width direction and side top panels forming both side portions in the seat width direction. The main top panel and each side top panel are individually secured to the seat frame.

The main top panel and the respective side top panels are bolted to the seat frame from the backside of the seat. Therefore, when the main top panel needs to be removed from the seat frame, the seat cushion must first be removed from the vehicle, making the process inefficient. There has been a need for a seat cushion that allows the main top panel, which is structurally separated from the respective side top panels, to be easily attached to and removed from the seat frame.

### SUMMARY

A seat cushion according to one aspect of the present disclosure has a cushion body for elastically supporting a seated person and a seat frame for supporting the cushion body from backside of a seat. The cushion body is composed of three separate elements. The three separate elements include a main top panel that forms a center portion in a seat width direction, and respective side top panels that form both side portions in the seat width direction. The main top panel has a main pad that forms a seat pad and a main base that is attached to a pad backside of the main pad. Each side top panel has a side pad forming a seat pad, and a side base attached to a pad backside of the side pad and secured to the seat frame. A first fitting portion and a second fitting portion are provided between the main base and each of the side bases. The first fitting portion is inserted from the seat upward direction of the main base to allow the main base and each of the side bases to be fitted to each other in a seat height direction. The second fitting portion allows the main base to be snap-fitted, preventing movement in the seat upward direction with respect to each side base upon insertion.

According to the first aspect of the present disclosure, the main top panel may be attached to each side top panel by simply being inserted from the seat upward direction, ensuring that it is not easily removed when in use. Specifically, the above insertion allows the main base to be fitted to each side base in the seat height direction by the first fitting portion while being prevented from being removed in the seat upward direction by the second fitting portion. The main top panel releases the snap-fitted state of the second fitting portion by pulling the main base in the seat forward direction such that it can be removed in the seat upward direction. Thus, the main top panel, which has a structure separated from each side top panel, can be easily attached to and removed from the seat frame.

In the second aspect of the present disclosure, the first fitting portion and the second fitting portion are formed between a main fitting portion formed on the main base and a side fitting portion formed on each said side base. Each side fitting portion protrudes from each side base so as to extend beyond a dividing line between the main top panel and each side top panel inwardly in the seat width direction. Each side fitting portion is fitted to the main fitting portion directly below the main top panel.

According to the second aspect of the present disclosure, the main top panel may be easily attached by pressing the main top panel in between the side top panels from the seat upward direction after each side top panel has been assembled to the seat frame. Further, only the main top panel can be easily removed from the seat frame without removing each side top panel from the seat frame.

In a third aspect of the present disclosure, the first fitting portion may have a recess-projection fitting structure formed of a projection and a recess. The projection is formed on the main base and protrudes in the seat downward direction. The recess is formed on the side base and opens in the seat upward direction. The second fitting portion has a claw-fitting structure consisting of a fitting hole and a fitting claw. The fitting hole is formed in the main base and penetrates the main base in the seat forward/rearward direction. The fitting claw is formed on each side base and protrudes in the seat forward direction.

According to the third aspect of the present disclosure, the first fitting portion and the second fitting portion may be formed to have a relatively simple structure between the main base and each side base.

In a fourth aspect of the present disclosure, the main base further has a frame hooking claw. The frame hooking claw is snap-fitted from the seat forward direction to prevent the movement of the main base in the seat upward direction with respect to the seat frame upon the insertion.

According to the fourth aspect, the main top panel may be attached by simply inserting into the seat frame from the seat upward direction so as not to be easily removed when in use. Furthermore, the main top panel may be removed in the seat upward direction by pulling the main base in the seat forward direction in a similar manner to the operation to release the fitted state of the second fitting portion to release the fitted state with the seat frame. Thus, the main top panel can be easily attached to and removed from the seat frame.

In a fifth aspect of the present disclosure, the seat frame has a pair of lower arms and a tilt frame. The pair of lower arms is aligned in a seat width direction and supports a seat rear portion of the cushion body from the backside of the seat. The tilt frame is connected about a tilt shaft extending between the pair of lower arms in the seat width direction so as to be position adjustable in the seat height direction to support a seat front portion of the cushion body from the backside of the seat. Each side base is secured to the tilt frame.

According to the fifth aspect, the main top panel and each side top panel may be attached to the seat frame having a tilt frame to properly follow the tilt movement.

In a sixth aspect of the present disclosure, the tilt frame has a pair of tilt arms and a tilt panel. The pair of tilt arms are aligned in the seat width direction and are connected to the pair of lower arms. The tilt panel extends in the seat width direction between front portions of the tilt arms. The main base has a base front portion and a base rear portion. The base front portion extends in an inverted U-shape in a plan view along upper sides of the pair of tilt arms and an upper side of the tilt panel. The base rear portion extends in a U-shape in a plan view along upper sides of the pair of lower arms and an upper side of a rear pipe extending in the seat width direction between the rear portions of the lower arms. The main base further includes a flexible portion. The flexible portion connects both ends of the inverted U-shape of the base front portion to the both ends of the U-shape of the base rear portion to follow the movement of the tilt frame upon deflection.

According to the sixth aspect, the main base may be configured to properly follow the tilt movement even if the main base is provided to be continuously connected to the seat frame, which performs the tilt movement, in a frame shape in a plan view over a movable part and a fixed part. The main base may be configured from a single component without dividing, ensuring to reduce the number of components and assembly hours appropriately.

### BRIEF DESCRIPTION OF THE DRAWINGS

FIG. 1 is a perspective view illustrating a schematic structure of a seat cushion according to a first embodiment.

FIG. 2 is an exploded perspective view of the seat cushion.

FIG. 3 is a perspective view of the seat cushion illustrating each side top panel attached to a cushion frame.

FIG. 4 is a bottom view of a cushion body.

FIG. 5 is a plan view of FIG. 3.

FIG. 6 is a perspective view of a main top panel in FIG. 3, showing a main base only.

FIG. 7 is a perspective view of the main base fitted to the cushion frame and each side base.

FIG. 8 is a vertical sectional view of a part VIII in FIG. 7.

FIG. 9 is a view seeing from an arrow IX in FIG. 6.

FIG. 10 is a vertical sectional view of a part X in FIG. 7.

FIG. 11 is a plan view of FIG. 7.

FIG. 12 is a cross-sectional view corresponding to FIG. 8, showing a main structure of a seat cushion according to a second embodiment.

### DETAILED DESCRIPTION

### First Embodiment

### Schematic Structure of Seat Cushion 1

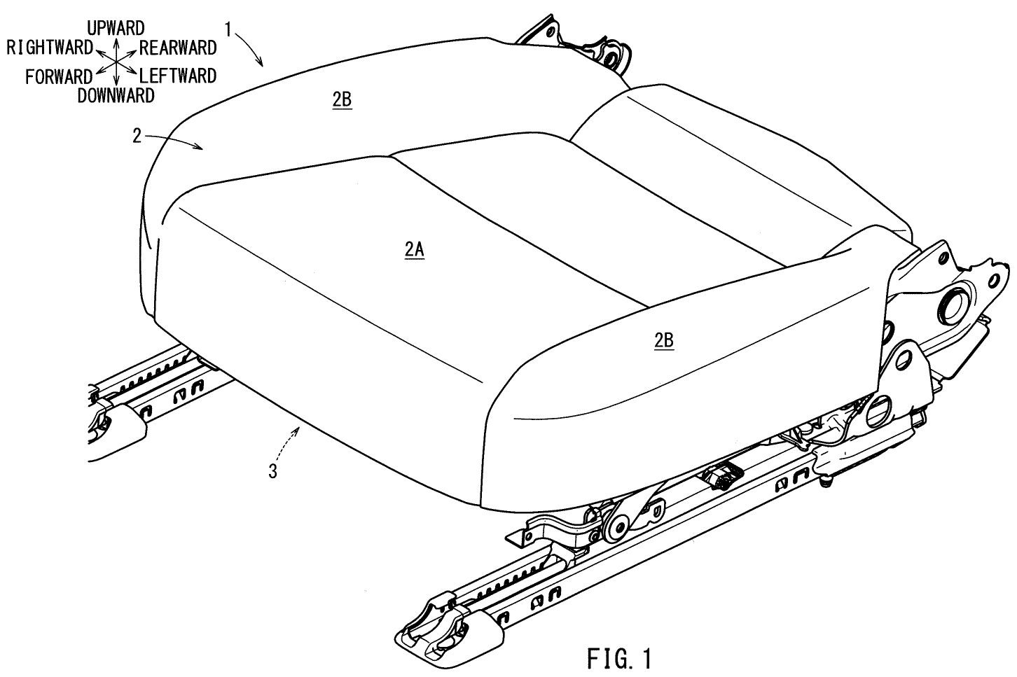

A structure of a seat cushion 1 according to a first embodiment will be described with reference to FIG. 1 to FIG. 11. In the following descriptions, when indicating each direction, such as forward, rearward, upward, downward, leftward and rightward, etc., the respective directions shown in each figure shall be referred to.

When indicating with a word “seat” in each direction, such as “seat width direction,” it shall refer respective directions with reference to the seat cushion 1. When specific reference figures are not shown, or when corresponding reference numerals are not shown in the reference figures, any one of FIG. 1 to FIG. 11 shall be referred to as necessary.

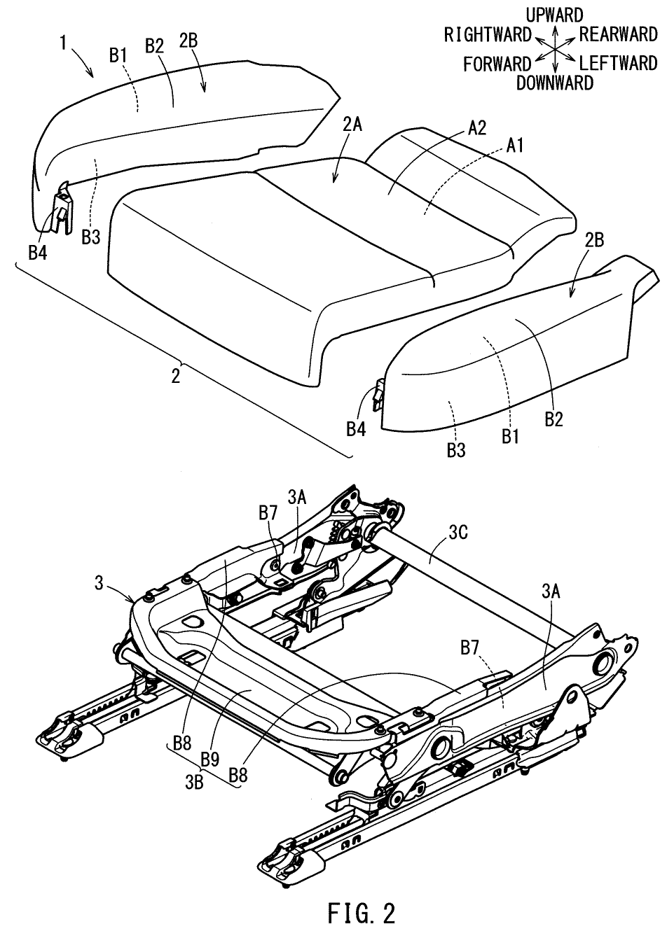

As shown in FIG. 1, the seat cushion 1 according to the present embodiment is configured as a seating portion of an automobile seat. As shown in FIG. 2, the seat cushion 1 includes a cushion body 2 for elastically supporting buttocks of a seated person and a cushion frame 3 for supporting the cushion body 2 from backside (underside) of the seat.

The cushion body 2 is divided into three separate elements including a main top panel 2A, which forms a center portion in the seat width direction, and respective side top panels 2B, which form both side portions in the seat width direction. The cushion frame 3 is made of a metal member assembled into a frame shape in a plan view. Here, the cushion frame 3 may correspond to a “seat frame” of the present disclosure.

The cushion body 2 is divided into a main top panel 2A and side top panels 2B, as described above, enabling the replacement of components according to the specifications for each separate element. The main top panel 2A and the side top panels 2B can be easily assembled to the cushion frame 3, generally only by accessing from the top of the seat.

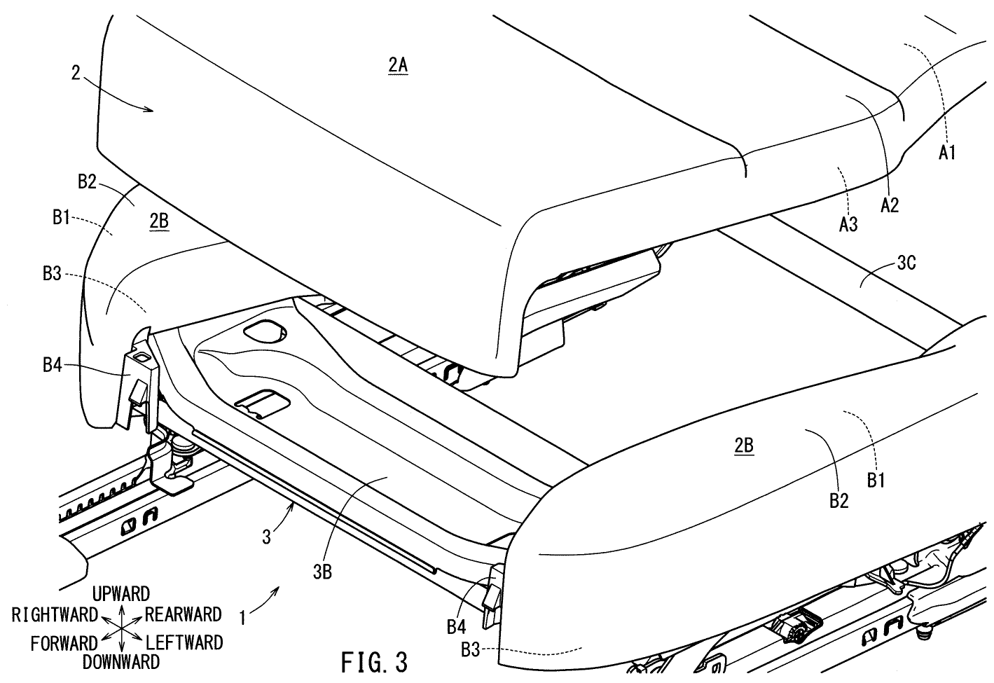

As shown in FIG. 3, specifically, each of the side top panels 2B is configured to be integrally secured to the cushion frame 3 by fastening using bolts (not shown). On the other hand, the main top panel 2A is configured to be snap-fitted and secured in position by being inserted between the side top panels 2B from the seat upward direction after the side top panels 2B are assembled to the cushion frame 3.

More specifically, the main top panel 2A is snap-fitted to both the respective side top panels 2B and the cushion frame 3 upon insertion as described above. Thereby, the main top panel 2A is assembled to the side top panels 2B and the cushion frame 3 with its removal in the seat upward direction restricted (assembled state shown in FIG. 1).

The fitted state (see FIG. 1) of the main top panel 2A to each side top panel 2B and the cushion frame 3 may be released by a simple operation in which an operator places his/her hand on a front part of the main top panel 2A from below and pulls it in a seat forward direction. This operation of pulling the front part of the main top panel 2A in the seat forward direction is different from the operation of removing the main top panel 2A in the seat upward direction.

Thus, the main top panel 2A can be securely attached to the cushion frame 3, ensuring that it is not easily removed when in use. Furthermore, the main top panel 2A can be easily removed and reinstalled by anyone who knows how to remove and install the main top panel 2A.

### Structure of Cushion Frame 3

As shown in FIG. 2, the cushion frame 3 has a pair of left and right lower arms 3A in an elongated plate shape extending in a seat forward/rearward direction along both left and right sides of the seat cushion 1.

The cushion frame 3 has a tilt frame 3B that is connected to extend between front portions of each lower arm 3A in the seat width direction. Further, the cushion frame 3 has a rear pipe 3C that is connected to extend between rear portions of each lower arm 3A in the seat width direction.

The tilt frame 3B is rotatably connected to each lower arm 3A via a tilt shaft B7 extending in the seat width direction. Specifically, the tilt frame 3B is formed into an inverted U-shape in a plan view, having a pair of left and right tilt arms B8 extending in the seat forward/rearward direction along each lower arm 3A, and a tilt panel B9 integrally extended between front portions of each tilt arm B8.

Each tilt arm B8 is made of a plate member having an L-shape in a cross-section extending in the sear forward/rearward direction along an inner part and an upper part of each lower arm 3A. Each tilt arm B8 is connected at its rear end to the corresponding lower arm 3A via each tilt shaft B7, so as to be rotatable around a common axis. The tilt panel B9 is formed of a panel-like member with its face expanding in a horizontal direction.

The tilt frame 3B is operated upon receiving transmission of driving force from a drive unit (not shown) connected between each lower arm 3A. Specifically, the tilt frame 3B is rotated around each tilt shaft B7 to adjust its position in a seat height direction relative to each lower arm 3A upon receiving the transmission of driving force from the drive unit.

The cushion frame 3 supports a rear portion of the cushion body 2 from the backside (underside) of the seat in a fixed position by means of the above-described each lower arm 3A and the rear pipe 3C. The cushion frame 3 also supports a front portion of the cushion body 2 from the backside (underside) of the seat by means of the above-described tilt frame 3B so that the front portion of the cushion body 2 can be adjusted in position in the seat height direction.

### Structure of Cushion Body 2

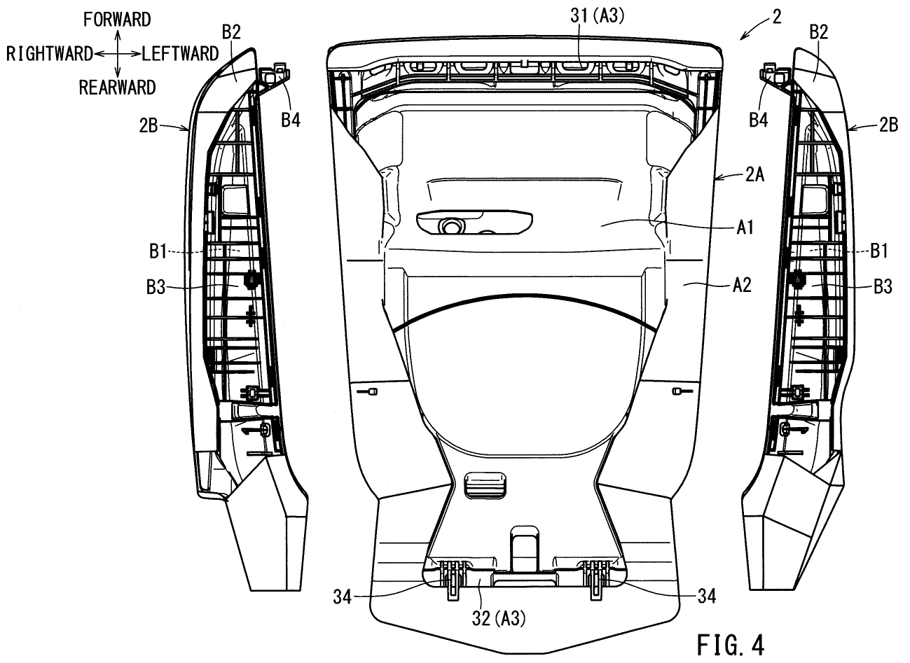

Next, structures of the main top panel 2A and each side top panel 2B, which constitute the cushion body 2, will be described. As shown in FIG. 4, the main top panel 2A has a main pad A1 made of urethane foam and a main cover A2 made of fabric that covers the main pad A1. The main top panel 2A further includes a main base A3 made of resin that is applied to the main pad A1 from backside of the pad.

The main cover A2 is covered over the main pad A1 from upside of the pad. Each of the front, rear, left and right cover ends of the main cover A2 is pulled into the backside of the main pad A1. Each cover end of the main cover A2 is then fastened to each circumferential edge of the main base A3 that is applied to the backside of the main pad A1.

Thereby, the main cover A2 is integrated with the main base A3 such that the main pad A1 is enclosed between the main cover A2 and the main base A3. As a result, the main base A3 is secured while being applied to the backside of the main pad A1 through the main cover A2.

As shown in FIG. 4, each side top panel 2B likewise has a side pad B1 made of urethane foam and a side cover B2 made of fabric that covers the side pad B1. Each side top panel 2B further includes a side base B3 made of resin that is applied to the side pad B1 from the backside.

Each side cover B2 is covered over the side pad B1 from the topside. Each of the front, rear, left and right cover ends of the side cover B2 is pulled into the backside of side pad B1. The cover ends of each side cover B2 are then fastened to each circumferential edge of the side base B3 that is applied to the backside of the side pad B1.

Thereby, each side cover B2 is integrated with the side base B3 such that the side pad B1 is enclosed between the side covers B2 and the side base B3. As a result, each side base B3 is secured while being applied to the backside of the side pad B1 through the side cover B2.

As shown in FIG. 2, the main top panel 2A and each side top panel 2B are individually assembled to the cushion frame 3 upon access from the seat upward direction. Specifically, each side top panel 2B is first assembled to the cushion frame 3. The procedure is as follows.

First, the side base B3 of each side top panel 2B is clip-fitted from the seat upward direction to be set to both the left and right sides of each tilt frame 3B. Thereby, each side base B3 is set while being applied from the seat upward direction and extending over both the left and right sides of each tilt frame 3B and each lower arm 3A.

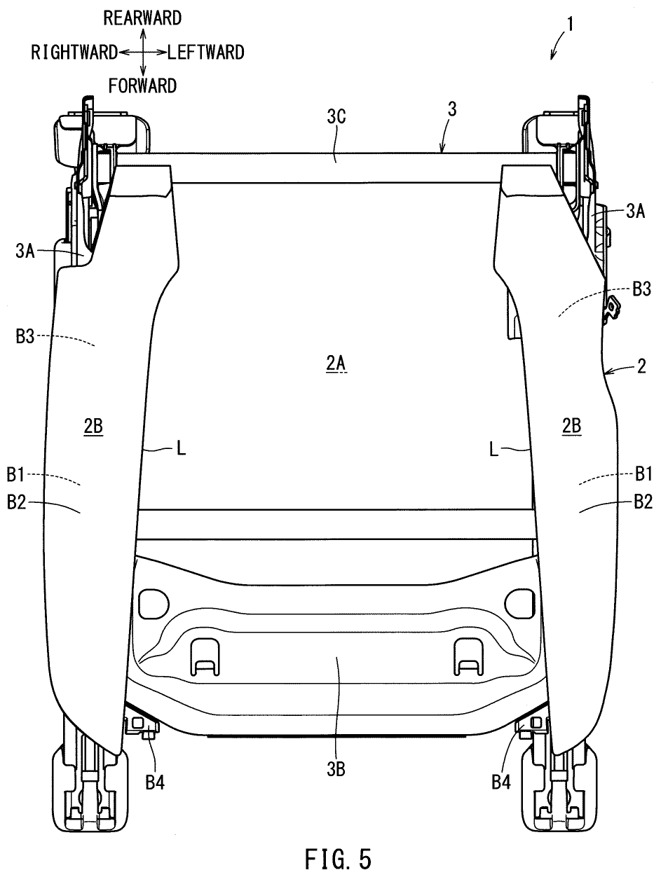

Next, each side base B3 is bolted to a portion protruding inwardly downward from each tilt arm B8. Thereby, as shown in FIG. 3 and FIG. 5, each side top panel 2B is secured integrally to the tilt frame 3B and set to be supported from the backside of the seat by the tilt frame 3B and each lower arm 3A.

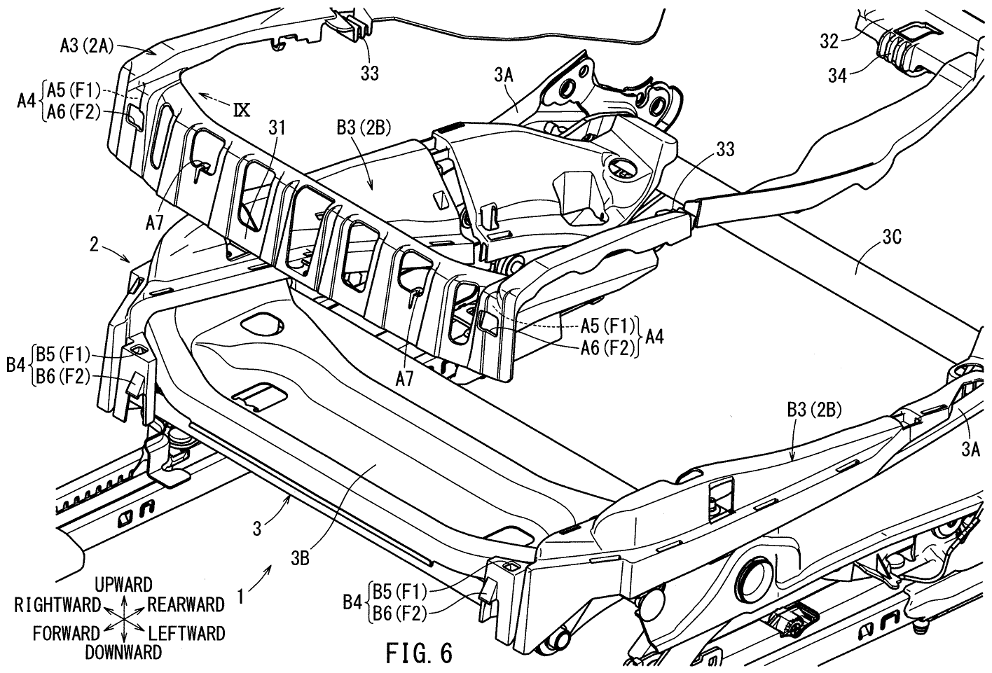

After being assembled as described above, the main top panel 2A is then assembled to the cushion frame 3. The procedure is as follows. As shown in FIG. 6, the main base A3 of the main top panel 2A is first inserted between each side top panel 2B assembled to the cushion frame 3 from the seat upward direction. FIG. 6 is a schematic view showing the main top panel 2A with only the main base A3.

A base rear portion 32 of the main base A3 is then dropped between each of the side top panels 2B such that a plurality of hooks 34 formed along the rear edge are fitted to grab the rear pipe 3C from the seat forward direction. Thereby, the rear portion 32 of the main base A3 is positioned with respect to the cushion frame 3.

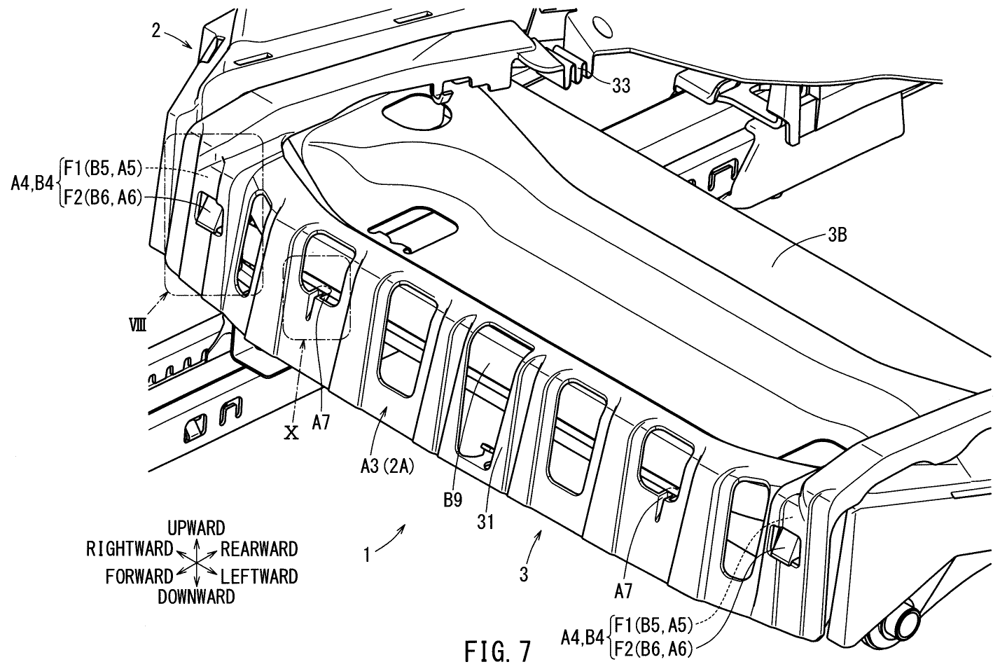

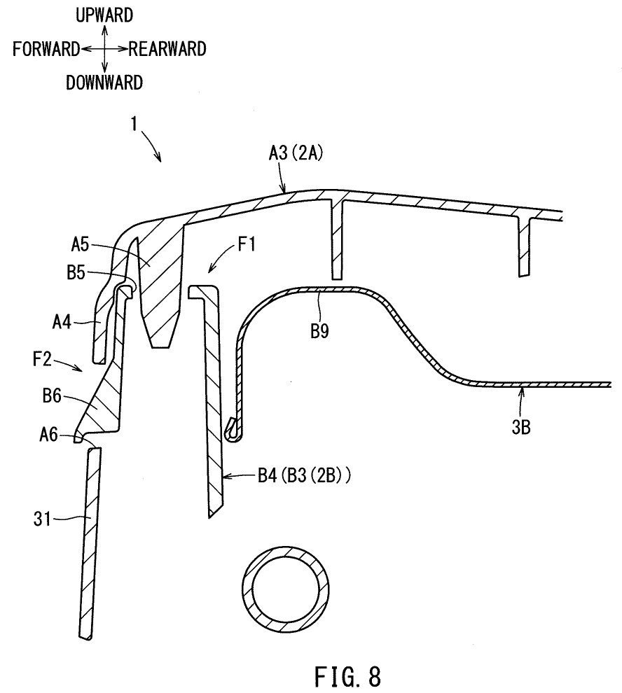

Next, the front portion 31 of the main base A3 is dropped onto the tilt frame 3B with the fitted rear pipe 3C as a fulcrum. Thereby, as shown in FIG. 7, each main fitting portion A4 (see FIG. 8) formed at both left-right ends on the front edge of the main base A3 is fitted to the side fitting portion B4 protruding inward in the seat width direction from the front end of each side base B3.

As shown in FIG. 5, each side fitting portion B4 protrudes from each side base B3 so as to extend inwardly in the seat width direction beyond a dividing line L between the main top panel 2A and each side top panel 2B. Thereby, each side fitting portion B4 fits with the main fitting portion A4 directly under the main top panel 2A (see FIG. 6).

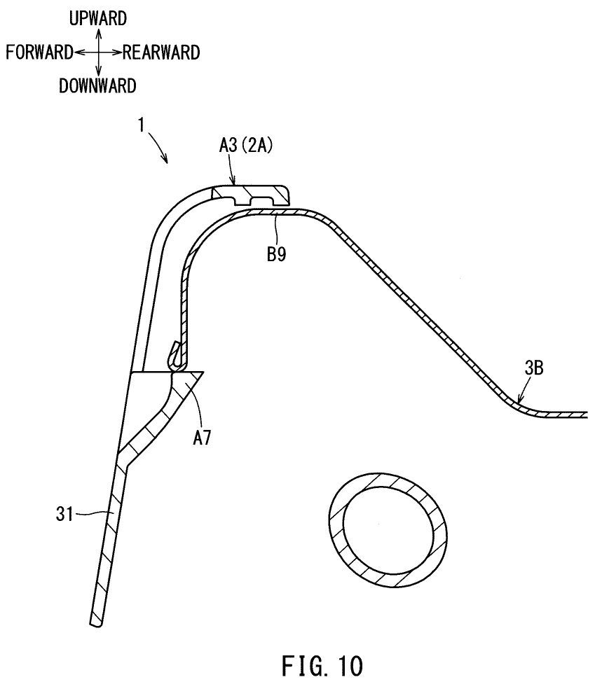

As shown in FIG. 7, furthermore, in addition to the above-described fitting, each frame hooking claw A7 (see FIG. 10) formed at two left-right locations at the front end of the main base A3 is snap-fitted to a lower edge of a front end of the tilt panel B9 from the seat forward direction. This fitting allows the main base A3 to be attached to both of each side base B3 and to the cushion frame 3 while being prevented from being removed in the seat upward direction.

Specifically, as shown in FIG. 8, a first fitting portion F1 is formed between each main fitting portion A4 and each side fitting portion B4. The first fitting portion F1 is fitted to the main fitting portion A4 and the side fitting portion B4 in the seat height direction upon insertion of the main base A3 from the seat upward direction. Further, a second fitting portion F2 is formed between each main fitting portion A4 and each side fitting portion B4. The second fitting portion F2 is snap-fitted from the seat forward direction such that the main base A3 cannot move in the seat upward direction with respect to each side base B3 upon insertion of the main base A3 from the seat upward direction.

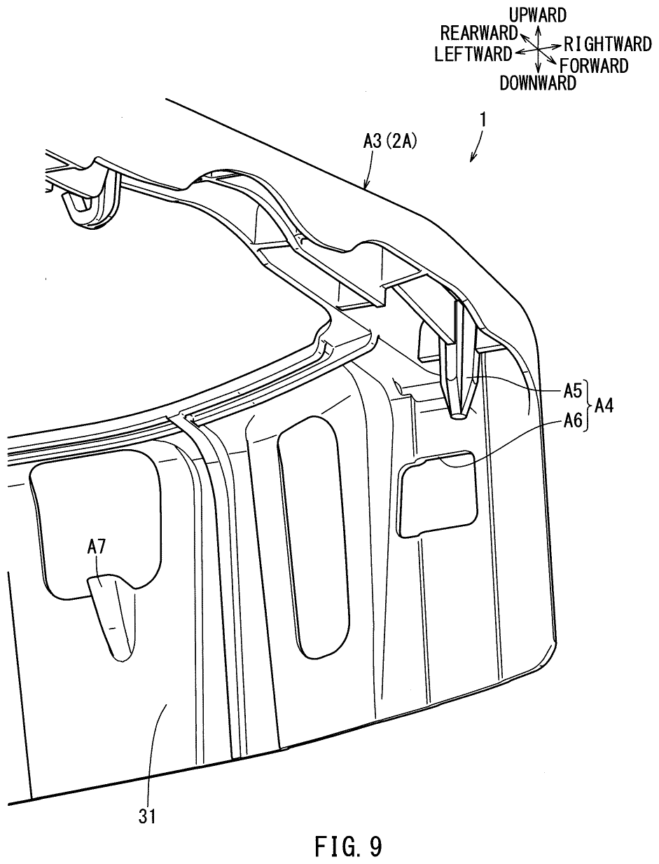

The first fitting portion F1 is formed by a recess-projection fitting structure consisting of a projection A5 (see FIG. 9) protruding in a seat downward direction formed on each main fitting portion A4 and a recess B5 opening in a seat upward direction formed in each side fitting portion B4. Each projection A5 has a shape as a round bar protruding from bottom of the front portion 31 of the main base A3 in the seat downward direction. The second fitting portion F2 is formed by a claw-fitting structure consisting of a rectangular hole-shaped fitting hole A6 penetrating in the seat forward/rearward direction formed in each main fitting portion A4 and a fitting claw B6 protruding in the seat forward direction formed on each side fitting portion B4. The fitting hole A6 is formed in a portion hanging down from the front edge of the front portion 31 of the main base A3 in the seat downward direction.

The first fitting portion F1 enters with the projection A5 into the recess B5 from the seat upward direction before the fitting claw B6 of the second fitting portion F2 fits into the fitting hole A6 upon insertion of the main base A3 from the seat upward direction. Furthermore, when inserted as described above, each main fitting portion A4 contacts each fitting claw B6 and is deflected forward.

After the projection A5 enters the recess B5, the main base A3 is inserted further in the seat downward direction, causing the fitting hole A6 to align with the front side of the fitting claw B6. This allows the fitting hole A6 to be snap-fitted to the fitting claw B6 from the seat forward direction with restorative deformation of the main fitting portion A4. The fitting claw B6 has a shape that protrudes in a right-angled triangular form in the seat forward direction in a side view.

As shown in FIG. 8, more specifically, a bottom side of the fitting claw B6 is formed as a flat surface oriented straight down in the seat downward direction, and the bottom side is contacted to a lower edge of the fitting hole A6. An upper side of the fitting claw B6 is an inclined surface inclined downward forward. Therefore, as the lower edge of the fitting hole A6 contacts the bottom side of this fitting claw B6 by snap-fitting, the main fitting portion A4 is restricted from moving in the seat upward direction relative to the side fitting portion B4.

As a result, the main base A3 is restricted from being removed in the seat upward direction with respect to each side base B3. This fitted state of the main base A3 to each side base B3 may be released when the operator places his/her hand on the portion hanging down from the front edge of the front portion 31 of the main base A3 in the seat downward direction from below and pulls each main fitting portion A4 in the seat forward direction.

Specifically, each main fitting portion A4 is pulled in the seat forward direction from the fitted state, thereby releasing the fitting hole A6 of each main fitting portion A4 from each fitting claw B6 in the seat forward direction. This allows each main fitting portion A4 to be released from the snap-fitted state with each side fitting portion B4 and move in the seat upward direction. Therefore, from this state, the main base A3 may be removed from each side base B3 in the seat upward direction by moving the main base A3 in the seat upward direction.

The main base A3 is inserted from the seat upward direction with respect to each side base B3. As shown in FIG. 7, each frame hooking claw A7 is formed at two left-right locations at the front end of the main base A3. Each frame hooking claw A7 is snap-fitted to a lower edge of the front end of the tilt panel B9 from the seat forward direction (see FIG. 10).

This snap-fitting may be released by pulling in the seat forward direction in the same manner as the snap-fitting at both left and right ends as described above. Specifically, this snap-fitting may be released when the operator places his/her hand on the portion hanging down from the front edge of the front portion 31 of the main base A3 in the seat downward direction from below and pulls in the seat forward direction. These fitting are released to move the main base A3 in the seat upward direction 3. As a result, the main base A3 may be removed from each side base B3 and the cushion frame 3 in the seat upward direction.

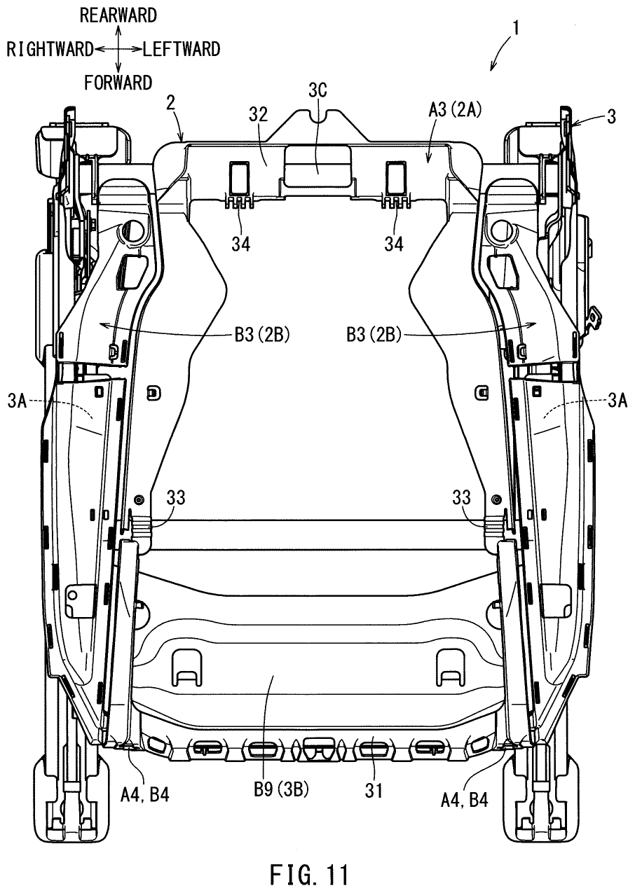

As shown in FIG. 6 and FIG. 11, the main base A3 is formed in a frame shape in a plan view extending along the cushion frame 3 assembled into the frame shape in a plan view. Specifically, the main base A3 has a base front portion 31 that extends in an inverted U-shape in a plan view along the upper side of the tilt panel B9 and the inside of the front region of each lower arm 3. The base front portion 31 is formed in a shape with its front edge hanging down in the seat downward direction to cover the tilt panel B9 from the seat forward direction (see FIG. 6).

The main base A3 has a base rear portion 32 that extends in a U-shape in a plan view along the inside of the rear region of each lower arm 3A and the upper side of the rear pipe 3C. The main base A3 also has a bellows-like flexible portion 33 that flexibly connects both inverted U-shaped ends of the base front portion 31 with both U-shaped ends of the base rear portion 32.

As shown in FIG. 6, the flexible portion 33 has a bellows structure. The bellows structure connects each end of the base front portion 31 to each end of the base rear portion 32 to follow the movement of the tilt frame 3B upon deflection. With this configuration, the main base A3 is supported with its entire circumferential area from the backside (underside) of the seat by the cushion frame 3. Even with this configuration, the main base A3 is able to follow the movement of the tilt frame 3B appropriately.

Therefore, the main base A3 may widely support the main pad A1 from the pad backside. The main base A3 may be configured from a single component by connecting the base front portion 31 and the base rear portion 32 into one, without dividing the main base A3 into the base front portion 31 and the base rear portion 32. This may reduce the number of components and assembly hours appropriately.

In summary, the seat cushion 1 according to the present embodiment is configured as follows. Hereinafter, the reference numerals indicated in parentheses are the reference numerals that correspond to the respective configurations presented in the above-described embodiments.

As shown in FIG. 2, the seat cushion (1) has a cushion body (2) for elastically supporting a seated person and a seat frame (3) for supporting the cushion body (2) from backside of a seat. The cushion body (2) includes three separate elements such as a main top panel (2A), which forms a center portion in the seat width direction, and each side top panel (2B), which forms both side portions in the seat width direction. The main top panel (2A) has a main pad (A1) that forms a seat pad and a main base (A3) (see FIG. 4) that is attached to the backside of the main pad (A1).

As shown in FIG. 4, each side top panel (2B) has a side pad (B1) that forms a seat pad and a side base (B3) that is attached to the backside of the side pad (B1) and secured to the seat frame (3). As shown in FIG. 8, a first fitting portion (F1) and a second fitting portion (F2) are formed between the main base (A3) and each side base (B3). The first fitting portion (F1) is fitted to the main base (A3) and the side base (B3) in the seat height direction upon insertion of the main base (A3) from the seat upward direction. The second fitting portion (F2) is snap-fitted from the seat forward direction such that the main base (A3) cannot move in the seat upward direction with respect to each side base (B3) upon insertion as described above.

According to the above configuration, the main top panel (2A) may be attached to each side top panel (2B) by simply inserting from the seat upward direction so as not to be easily removed when in use. Specifically, by the above insertion, the main base (A3) may be fitted to each side base (B3) in the seat height direction by the first fitting portion (F1) while being prevented from being removed in the seat upward direction by the second fitting portion (F2). The main top panel (2A) releases the snap-fitted state of the second fitting portion (F2) by pulling the main base (A3) in the seat forward direction such that it can be removed in the seat upward direction. Thus, the main top panel (2A), which has a structure separated from each side top panel (2B), may be easily attached to and removed from the seat frame (3).

As shown in FIG. 8, the first fitting portion (F1) and the second fitting portion (F2) are formed between the main fitting portion (A4) formed on the main base (A3) and the side fitting portion (B4) formed on each side base (B3). Each side fitting portion (B4) protrudes from each side base (B3) so as to extend beyond a dividing line (L) between the main top panel (2A) and each side top panel (2B) inwardly in the seat width direction, and is fitted to the main fitting portion (A4) directly below the main top panel (2A).

According to the above configuration, the main top panel (2A) may be easily attached by pressing the main top panel (2A) in between each side top panel (2B) from the seat upward direction after each side top panel (2B) has been assembled to the seat frame (3). Further, only the main top panel (2A) may be easily removed from the seat frame (3) without removing each side top panel (2B) from the seat frame (3).

As shown in FIG. 8, the first fitting portion (F1) may have a recess-projection fitting structure including a projection (A5) formed on the main base (A3) and projecting in the seat downward direction, and a recess (B5) formed on each side base (B3) and opening in the seat upward direction. The second fitting portion (F2) has a claw-fitting structure consisting of a fitting hole (A6) formed in the main base (A3) and penetrating in the seat forward/rearward direction, and a fitting claw (B6) formed on each side base (B3) and protruding in the seat forward direction. According to the above configuration, the first fitting portion (F1) and the second fitting portion (F2) may be formed to have a relatively simple structure between the main base (A3) and each side base (B3).

As shown in FIG. 9 and FIG. 10, the main base (A3) further includes a frame hooking claw (A7) that is snap-fitted from the seat forward direction to the seat frame (3) to prevent the movement in the seat upward direction with respect to the seat frame (3) upon the said insertion. According to the above configuration, the main top panel (2A) may be attached by simply inserting into the seat frame (3) from the seat upward direction so as not to be easily removed when in use. On the other hand, the main top panel (2A) may be removed in the seat upward direction by pulling the main base (A3) in the seat forward direction in a similar manner to the operation to release the fitted state of the second fitting portion (F2) to release the fitted state with the seat frame (3). Thus, the main top panel (2A) may be easily attached to and removed from the seat frame (3).

As shown in FIG. 2, the seat frame (3) includes a pair of lower arms (3A) in the seat width direction for supporting a seat rear portion of the cushion body (2) from backside of the seat, and a tilt frame (3B) connected about a tilt shaft (B7) extending between the pair of lower arms (3A) in the seat width direction so as to be position adjustable in the seat height direction to support the seat front portion of the cushion body (2) from the backside of the seat. Each side base (B3) is secured to the tilt frame (3B). According to the above configuration, the main top panel (2A) and each side top panel (2B) may be attached to the seat frame (3) having the tilt frame (3B) to properly follow the tilt movement.

As shown in FIG. 4, the main base (A3) has a base front portion (31) and a base rear portion (32). As shown in FIG. 2, the base front portion (31) extends in an inverted U-shape in a plan view along the upper sides of the pair of tilt arms (B8) in the seat width direction that are connected to the pair of lower arms (3A) of the tilt frame (3B) and along the upper side of the tilt panel (B9) that extends between front portions of the pair of tilt arms (B8) in the seat width direction. The base rear portion (32) extends in a U-shape in a plan view along the upper sides of the pair of lower arms (3A) and along the upper side of the rear pipe (3C) extending between the rear portions of the pair of lower arms (3A) in the seat width direction.

As shown in FIG. 6, the main base (A3) has a flexible portion (33). The flexible portion (33) connects both ends of the inverted U-shape of the base front portion (31) shown in FIG. 4 to both ends of the U-shape of the base rear portion (32) to follow the movement of the tilt frame (3B) shown in FIG. 6 upon deflection. According to the above configuration, the main base (A3) may be configured to follow the tilt movement properly even if the main base (A3) is provided to be continuously connected to the seat frame (3), which performs the tilt movement, in a frame shape in a plan view over a movable part and a fixed part. Therefore, the main base (A3) may be configured from a single component without dividing. The number of components and assembly hours may be reduced appropriately.

### Second Embodiment

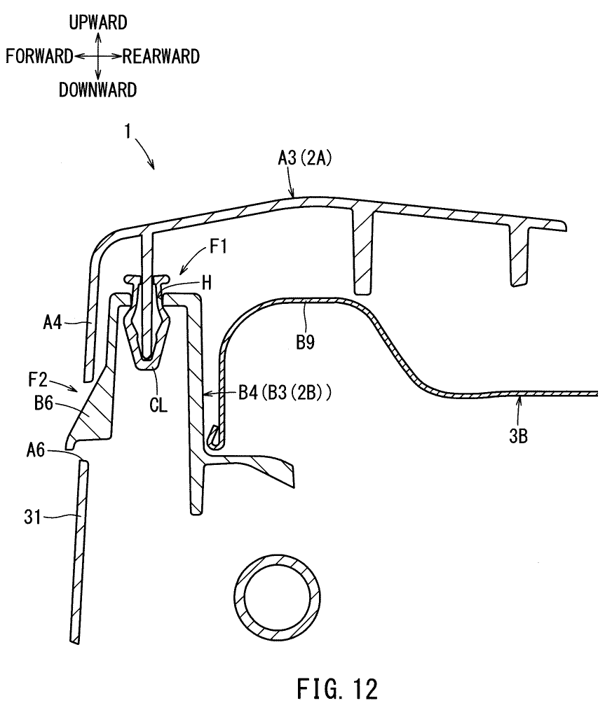

A structure of a seat cushion 1 according to a second embodiment will be described with reference to FIG. 12. In this embodiment, a first fitting portion F1 that allow each main fitting portion A4 and each side fitting portion B to be fitted to each other in the seat height direction upon insertion of the main base A3 from the seat upward direction is configured as follows.

The first fitting portion F1 shown in FIG. 12 is formed by a recess-projection fitting structure consisting of a clip CL and a through-hole H, instead of the projection A5 formed on each main fitting portion A4 described in the first embodiment (see FIG. 8 and FIG. 9). The clip CL is attached to each main fitting portion A4. The through hole H is formed in each side fitting portion B4 and opening in the seat upward direction. Here, each clip CL may correspond to a “projection” of the present disclosure. Further, each through hole H may correspond to a “recess” of the present disclosure.

As shown in FIG. 12, each clip CL is made of a metal leaf spring that is provided to protrude from the bottom side of the front portion 31 of the main base A3 in an inverted Ω-shape in the side view in the seat downward direction. Each clip CL is pushed into the through hole H formed in each side fitting portion B4 from the seat upward direction with elastic deformation upon insertion of the main base A3 from the seat upward direction.

Specifically, each clip CL is inserted into the through hole H such that the front and rear bulges of the Ω-shape are squeezed in as the main base A3 is inserted. Each clip CL is inserted into the through hole H until the bulged portions of the Ω-shape have reached the point beyond the through hole H in the seat downward direction.

Thereby, each clip CL recovers in response to the resilient force at the point where its bulged portions have reached beyond the through holes H in the seat downward direction. Each clip CL is snap-fitted to the lower edge of each through hole H so as not to be easily removed in the seat upward direction. More specifically, each clip CL touches the lower edge of each through hole H from below at an angle with its two upper inclined surfaces on the base side of its bulged portions. This fitting allows the main base A3 to be fitted to each side base B3 in such a way that it is less likely to rattle in the seat height direction.

The resilient force exerted on each through-hole H of each clip CL is set to such a level to allow a worker to easily remove the main base A3 by applying a force to pull it in the seat upward direction. Therefore, the attachment and removal work may be easily carried out. Since the configuration other than the above-described configuration is identical to that described in the first embodiment, the same reference numerals are assigned and redundant description is omitted.

### Other Embodiments

Although the embodiments of the present disclosure have been described above referring to two embodiments, the present disclosure may be carried out in various other forms in addition to the above-described embodiments.

The seat cushion of the present disclosure may be applied to seats for vehicles other than automobiles, such as trains, aircraft, and vessels. The seat cushion may also be applied to seats for non-vehicles that may be installed in various facilities such as sports facilities, theaters, concert halls, event halls, and the like, other than vehicles.

The second fitting portion may be configured to have a fitting claw formed on the main base and protruding in the seat rearward direction and a fitting hole formed in each side base and receiving the fitting claw from the seat forward direction. The second fitting portion may also be configured to have a fitting structure of claws that are snap-fitted to each other.

The seat frame may not have a tilt frame but may support the cushion body in place from the backside (underside) of the seat. The main cover and/or the side covers may be made of leather material instead of fabric. The main base and/or the side base may be made of metal instead of resin or the like. The main base may be attached to the backside of the main pad by adhesion or integral molding. The side base may likewise be attached to the backside of the side pad by adhesion or integral molding.

The main base may consist of two parts, with the base front portion and the base rear portion separated from each other. Furthermore, in the case where the main base has a flexible portion connecting the base front portion and the base rear portion to follow the movement of the tilt frame, the flexible portion may be formed of an integral hinge instead of being in the form of a bellows. Alternatively, the flexible portion may be configured to connect between the base front portion and the base rear portion by inserting another material such as a leaf spring or the like.

What is claimed is:

1. A seat cushion comprising:
a seat frame, and
a cushion body supported by the seat frame from a backside, the cushion body includes
a main top panel configured to form a center portion in a seat width direction, wherein the main top panel includes a main pad to form a seat pad and a main base attached to a pad backside of the main pad, and
first and second side top panels configured to form both side portions in the seat width direction, wherein each of the first and second side top panels includes a side pad to form a seat pad and a side base attached to a pad backside of the side pad and secured to the seat frame,
wherein a first fitting portion provided between the main base and the side base of the first side top panel is configured to fit the main base to the side base of the first side top panel in a seat height direction upon insertion of the main base from a seat upward direction, and
wherein a second fitting portion provided between the main base and the side base of the first side top panel is configured for the main base to be snap-fitted to the side base of the first side top panel from a seat forward direction, preventing a movement of the main base with respect to the side base of the first side top panel in the seat upward direction.

2. The seat cushion according to claim 1, wherein the first fitting portion and the second fitting portion are formed between a main fitting portion formed on the main base and a side fitting portion formed on the side base of the first side top panel,
wherein the side fitting portion protrudes from the side base of the first side top panel so as to extend beyond a diving line between the main top panel and the first side top panel inwardly in the seat width direction, and wherein the side fitting portion is configured to fit to the main fitting portion directly below the main top panel.

3. The seat cushion according to claim 2, wherein the first fitting portion includes a projection formed on the main base and projecting in a seat downward direction, and a recess formed in the side base of the first side top panel and opening in the seat upward direction,
wherein the second fitting portion includes a fitting hole formed in the main base and configured to penetrate the main base in forward/rearward direction, and a fitting claw formed on the side base of the first side top panel and protruding in the seat forward direction.

4. The seat cushion according to any one of claims 1, wherein the main base further includes a frame hooking claw, and the frame hooking claw is configured to be snap-fitted from the seat forward direction to prevent a movement of the main base in the seat upward direction with respect to the seat frame upon the insertion of the main base.

5. The seat cushion according to any one of claims 1, wherein the seat frame includes
a pair of lower arms configured to support a seat rear portion of the cushion body from a backside of a seat and aligned in the seat width direction,
a tilt shaft extending between the pair of lower arms in the seat width direction, and
a tilt frame connected about the tilt shaft so as to be position adjustable in the seat height direction to support a seat front portion of the cushion body from the backside of the seat,
wherein the side bases of the first and second side top panels are secured to the tilt frame.

6. The seat cushion according to claim 5, wherein the tilt frame includes
a pair of tilt arms connected to the pair of lower arms and aligned in the seat width direction, and
a tilt panel extending between front portions of the pair of tilt arms in the seat width direction, and
wherein the main base includes
a base front portion extending in an inverted U-shape in a plan view along upper sides of the pair of tilt arms and an upper side of the tilt panel,
a base rear portion extending in a U-shape in a plan view along upper sides of the pair of lower arms and an upper side of a rear pipe extending between the pair of lower arms in the seat width direction, and
a flexible portion configured to connect both ends of the inverted U-shape of the base front portion to both ends of the U-shape of the base rear portion and to follow the movement of the tilt frame upon deflection.

7. A seat cushion comprising:
a cushion body having
a main top panel, wherein the main top panel has a main pad, a main cover, and a main base attached to a pad backside of the main pad, and
respective side top panels, wherein each of the respective side top panels has a side pad, a side cover, and a side base; and
a seat frame having
a pair of lower arms aligned in a seat width direction and configured to support a rear portion of the cushion body,
a tilt frame connected about a tilt shaft extending between the pair of lower arms and being adjustable in a seat height direction to support a front portion of the cushion body, and
a rear pipe configured to extend between rear portions of the pair of lower arms in the seat width direction.

8. The seat cushion according to claim 7, wherein the main base has a main fitting portion each formed at both left and right ends on a front end of the the main base.

9. The seat cushion according to claim 8, wherein the main fitting portion has a projection that protrudes in a seat downward direction and a fitting hole that penetrates in a seat forward/rearward direction.

10. The seat cushion according to claim 7, wherein the side base has side fitting portions that protrude inwardly to fit with the main fitting portion of the main base.

11. The seat cushion according to claim 10, wherein the projection is configured to fit into a recess on the side fitting portions for the main base to be fitted in a seat height direction upon insertion from a seat upward direction.

12. The seat cushion according to claim 11, wherein each of the side fitting portions has a fitting claw that protrudes in the seat forward direction and is configured to snap-fit into the fitting hole on the main fitting portion.

13. The seat cushion according to claim 7, wherein the main base further has a frame hooking claw that snap-fits to the seat frame for preventing upward movement and ensuring the main top panel remains securely in place during use.

14. The seat cushion according to claim 7, wherein the main base further has a flexible portion that connects front and rear portions allowing the main base to follow the tilt frame and providing flexibility and adaptability to a seat tilt adjustment.

15. The seat cushion according to claim 7, wherein the tilt frame has a pair of left and right tilt arms extending in a seat forward/rearward direction along an inner part and an upper part of each of the pair of lower arms, a tilt panel extending between front portions of the pair of left and right tilt arms in the seat width direction, and a tilt shaft configured for the tilt frame to be position adjustable in the seat height direction.

16. The seat cushion according to claim 15, wherein the tilt frame is rotatably connected 5 to each of the pair of lower arms via the tilt shaft extending in the seat width direction.
